(19) United States
(12) Patent Application Publication
(10) Pub. No.: US 2015/0092189 A1
(43) Pub. Date: Apr. 2, 2015

(54) SPRAY ANALYSIS SYSTEM AND METHOD

(71) Applicant: InnovaSystems, Inc., Moorestown, NJ (US)

(72) Inventor: John J. Waters, Moorestown, NJ (US)

(21) Appl. No.: 14/504,411

(22) Filed: Oct. 1, 2014

Related U.S. Application Data
(60) Provisional application No. 61/885,444, filed on Oct. 1, 2013.

(51) Int. Cl. G01N 21/85; G01N 15/02

(52) U.S. Cl. CPC G01N 21/85; G01N 15/0227; G01N 2201/062
USPC 356/213

(57) ABSTRACT

A spray measuring device/system and method can include a device, and the use of the device, that incorporates an actuation device, an illumination device, and a camera that obtains data relative to a spray event via a single exposure of the camera shutter. The actuation device can be configured to actuate a spray device such as a metered dose inhaler to create a spray event. The camera can include a shutter configured to open and close a single time during the spray event to obtain a single exposure or single image of the spray event. A controller can be provided in communication with the actuation device, the camera and an illumination device, and can be configured to cause the shutter of the camera to open one single time during the spray event. The illumination device can be an LED light source.

This application is a continuation of and claims priority under 35 U.S.C. §119(e) to U.S. Provisional Patent Application No. 61/885,444, filed on Oct. 1, 2013, the disclosure of which is incorporated herein by reference in its entirety.

### BACKGROUND

1. Field

The present disclosure relates to an apparatus and method for testing spray plume, spray pattern, particle size, particle distribution, and other characteristics of various spray devices, including metered dose inhaler units, nasal inhalers, as well as other known spray devices.

2. Background

Medicinal drug formulations useful in inhalation therapy for treating respiratory disorders, such as asthma, are frequently administered to patients orally or nasally in metered, aerosolized doses. Such aerosolized drug formulations are commonly provided in the form of a suspension or emulsion consisting of (or including) a pharmaceutical compound in micronized powder form and a suspending medium such as a liquefied gas or propellant. Of course, various other forms of drug formulations are possible for use with spray/dosing devices, such as pure liquids, gas/liquid, particulate/gas mixtures, etc. The suspension or dosing medium is initially stored, for example, within a sealed canister configured to withstand the pressure required to maintain the propellant in liquid form. The suspension can then be dispensed in metered, aerosolized doses from the canister upon actuation of an atomized delivery device such as a metered dose inhaler (MDI) unit (or other of a variety of atomized delivery devices which are well-known in the pharmaceutical and dose delivery industries).

In order to insure that each delivery device is operating properly (e.g., providing a proper dose, spray pattern, plume configuration, etc.) spray pattern/plume measuring devices have been used to test the delivery devices either randomly for quality testing, or during manufacture for qualification or validation testing. Conventional spray measuring devices include an actuation mechanism for actuating the spray delivery device, a light source for illuminating the spray during testing, a camera for recording the illuminated spray event, and a controller(s). The controller(s) can be used to time and control parameters for each of the events (e.g., sequencing the actuation of each the components), to record and store data from each spray event, and to analyze data from the spray event. In addition, the controller could be programmed to make adjustments to each of the components during or after a spray event.

One conventional device uses a high-speed digital 640×480 camera that can operate at up to 2000 frames per second. During operation the camera may record about 150 frames for a spray event, for example. The light source can be a low power laser that emits a continuous beam at a wavelength of 660 nm. The light can have a power rating of 50 milliwatts and include an optical assembly configured to disperse light in a 30 degree angle formed as a single sheet of light along an illumination axis. A rotary frame support can be provided to hold the spray device, and can orient the spray device in a variety of positions including 0 and 90 degree positions with respect to the illumination axis. A Data Acquisition Board (Camera Link) can be provided to connect to the camera and obtain and store data (in addition to or integral with the controller). This conventional spray pattern measuring device can perform spray pattern and plume geometry tests. Once the spray has been captured, a Crop Start Frames and an End Crop Frame buttons can be programmed to appear on a terminal associated with one of the controller(s). Image sequence can be examined one frame at a time via a video monitor connected to the controller(s). After capturing the spray event, the frames included for analysis can be changed by updating the Crop Start Frame and Crop End Frame

Typically, the video camera will record images at a frame rate of from 250 frames per second (“FPS”) to about 500 FPS. For a spray event that lasts approximately 0.75 seconds, which is typical, the spray devices would therefore collect from about 137 to about 375 images in a sequence that follows and records the history or a portion of the history of the spray event.

This use of a video camera to capture a sequence of images has certain advantages. One such advantage is the ability to obtain and retain data that represents how the spray plume changes with time. For example, in a sequence of 187 images, each image represents the condition of the plume at a point in time just slightly advanced from the previous image. As a result, in the conventional spray devices the user is able to toggle through the collected images sequentially, to review and visually observe the changes with the spray plume over time, and to make adjustments as to which and how much of the sequence data will be used in the analysis of the plume.

The conventional spray devices often use a laser that projects a sheet of light. When the spray plume is created, laser light illuminates a cross section of the spray plume as it traverses the light sheet.

### SUMMARY

In developing the spray device according to the presently disclosed subject matter, several disadvantages associated with the use of the conventional spray devices, which utilize a sequence of images as the basis of the data collection during spray analysis, were recognized and addressed. For example, when a sequence of images is collected in the conventional devices, for each of the images collected the individual pixel image intensity corresponds to the amount of light that fell on that pixel during each exposure. Typically in the conventional devices, exposure lasts about 0.002 seconds to 0.005 seconds. Mathematical operations are then performed on the image intensities in each exposure at each pixel, and then the field of pixels representative of the image is normalized in order to achieve a mathematically generated composite image based on the image sequences. More specifically, the resulting sequence of image intensities are summed at each pixel and the resulting field of intensities is normalized in order to scale the resulting intensities between desired values for the purposes of obtaining a composite image which can then be analyzed. Using the sequence of images and manipulating those images mathematically, as is the case for conventional spray measuring devices, can potentially result in an undesirable and potentially disadvantageous loss of information and/or image resolution. More specifically, since the intensity of each pixel in each image is mathematically summed to create total pixel intensity, the summation value can and frequently does exceed the maximum intensity that can be represented in the selected image format. For example, if an 8-bit format is used for the images, each pixel value varies between 0 and 255 and the sum of the values can and frequently do exceed 225. In order to accommodate this problem, a scale factor is computed in order to ratio the maximum intensity in the summed image to a value of 255. The summed intensities at each pixel are multiplied by this scale factor in order to produce a final 8-bit image. One potential problem with this approach is that a single scale factor must be used for all pixels, potentially resulting in a loss of accuracy and/or resolution for those pixels for which the overall scale factor might not be precisely accurate and/or having relatively low intensities.

Another example of a loss of information that can occur when a sequence of images is used, as in the conventional spray measuring devices, is that a video camera that acquires a sequence of images is not acquiring images all the time. All digital cameras, whether they are video cameras or otherwise, include a component that is called a “sensor.” The purpose of the sensor is, as the name indicates, to sense and record the light that is being received through the camera lens. Each image in the sequence is acquired in the pixels of the sensor during the exposure time, and then the photo-electrons in the sensor pixels are “read out” and digitized. This process involves converting the electrical charges accumulated in each pixel during the exposure to voltages that represent the intensity of light that fell on that pixel. These voltages are then converted to digital values and sent to the host computer. If there are fast transient events, they can fall into the times when the image is being transferred from the pixels to digital values, and may not be recorded using the sequential image collection technique used in conventional spray measuring devices. Thus, the intensity data from transient events can be lost and not taken into account during the analysis process. This in turn can result in a loss of accuracy in the analysis results.

Additionally, sequential imaging (video type) devices are typically more expensive and require more (or at least different types of and more frequent) calibration than does a single exposure camera device. Additionally, more powerful lighting is typically required when using a conventional spray measuring device that incorporates sequential or video imaging.

With respect to the use of lasers, the disclosed subject matter has been devised in response a long felt need to allay certain disadvantages that have been recognized when using such laser systems in conventional art devices. For example, certain disadvantages exist at least in part because of the highly coherent light produced by laser systems. More specifically, when a laser illuminates a surface (in the case of a spray analyzer, the surface of the particles that make up the spray), irregularities in the surface make the path of the light from the laser to the surface and then to the detector (eye or camera) vary in length slightly at closely spaced locations on the illuminated surface. If this distance is ½ of the light wavelength, the different parts of the beam cancel and a dark spot is seen. This results in the well-known property of laser speckle. The surface thus does not appear to be uniformly illuminated but to have light and dark portions in close proximity.

Thus, it has presently been recognized and appreciated that, in the measurement of sprays using laser light, the light and dark points produced by the laser speckle effect move in unpredictable ways as the droplets pass through the laser light sheet and that there exists a need to correct spray measurement devices for this issue. Bright intensities can be much brighter than the average intensity and dark points can be completely dark. In measuring a spray pattern using a laser light sheet, these light and dark points are expected to “average out.” In the conventional spray measuring devices which use a sequence of images (i.e., video) as the source of the image data, the light and dark points that occur while the light intensities in the pixels are being read out and digitized are not included in the averaging process, creating an inaccuracy in the data.

According to one aspect of the presently disclosed subject matter, a spray measuring device can include an actuation device (configured to actuate a spray device to create a spray event), an illumination device, a camera having a shutter (either electronic or mechanical) configured to operate with long exposure times, preferably having exposure times that are on the order of magnitude of the spray event, and even more preferably to open and close a single time during the spray event to obtain a single exposure, and a controller in communication with the actuation device, the camera and the illumination device, and configured to cause the shutter or exposure of the camera to operate with long exposure times, and even more preferably to open or create an exposure during one single time period during the spray event.

According to another aspect of the disclosed subject matter, a spray measuring device can include an actuation device (configured to actuate a spray device to create a spray event), an illumination device comprising a light emitting diode (LED) light source, an illumination device, a camera to obtain at least one image of the spray event, and a controller in communication with the actuation device, the camera and the illumination device and configured to operate the camera to obtain said at least one image of the spray event.

According to another aspect of the disclosed subject matter, a spray measuring device can include a controller configured to cause the camera to utilize an exposure time of about 0.2 seconds or greater.

According to another aspect of the disclosed subject matter, the spray measuring device can include a camera having a lens with a focal length of from 16 to 25 mm. The illumination device can be a 3 Watt LED lamp having various wavelength light, including blue 460 nm, green 520 nm, red 630 nm, combinations thereof, etc. Multiple LED lamps can be used, and each lanp can have a different characteristic such as pattern, wavelength or intensity such that different data can be easily distinguished, especially if the multiple LED's are focused at the same location of the spray event.

According to another aspect of the disclosed subject matter, the controller can include a portion integrated into the camera. The spray measuring device can also include a monitor, and the controller can be connected to the monitor.

According to yet another aspect of the disclosed subject matter, a method for analyzing a spray event can include providing a camera and a spray device configured to be actuated to create a spray event, actuating the spray device to cause the spray event, and operating the camera for an exposure time of 0.2 seconds or longer and even more preferably for only a single time during the spray event to obtain a single exposure of the spray event.

According to yet another aspect of the disclosed subject matter, a method for analyzing a spray event can include: (a) providing a camera, an illuminator and a spray device configured to be actuated to create a spray event, said illumination device comprising a light emitting diode (LED) light source; (b) actuating the spray device to cause the spray event; (c) illuminating the spray event with said illumination device; and (d) operating the camera to obtain at least one image of the spray event.

According to another aspect of the disclosed subject matter, the method can include providing an actuation device configured to cause the actuation of the spray device, and providing a controller in communication with the actuation device and the camera and configured to cause the camera to operate with an exposure time of 0.2 seconds or longer and even more preferably to obtain one single exposure of the spray event.

According to another aspect of the disclosed subject matter, the camera is operated to obtain an exposure time of about 0.1 seconds or greater during the spray event.

According to another aspect of the disclosed subject matter, the method includes forming an image of the spray event based on an exposure time of from about 0.2 to 0.5 seconds. In addition, the method can include analyzing a light intensity value which is collected directly and without scale factoring from each pixel of the camera.

According to another aspect of the disclosed subject matter, the method can include providing a controller and a monitor, the controller configured to cause the camera to obtain a single exposure of the spray event. The method can also include obtaining data related to the spray event from the camera and storing the data in a controller. According to yet another aspect, the method can include illuminating the spray event with an LED light source.

### BRIEF DESCRIPTION OF THE DRAWINGS

FIG. 1 is a schematic representation of one embodiment of a spray measuring device/system made in accordance with principles of the presently disclosed subject matter;

FIG. 2 is a perspective view of an embodiment of an LED light source for use with the system of FIG. 1; and

FIG. 3 depicts and describes an embodiment of an LED light source for use with the system of FIG. 1.

### DETAILED DESRIPTION OF EXEMPLARY EMBODIMENTS

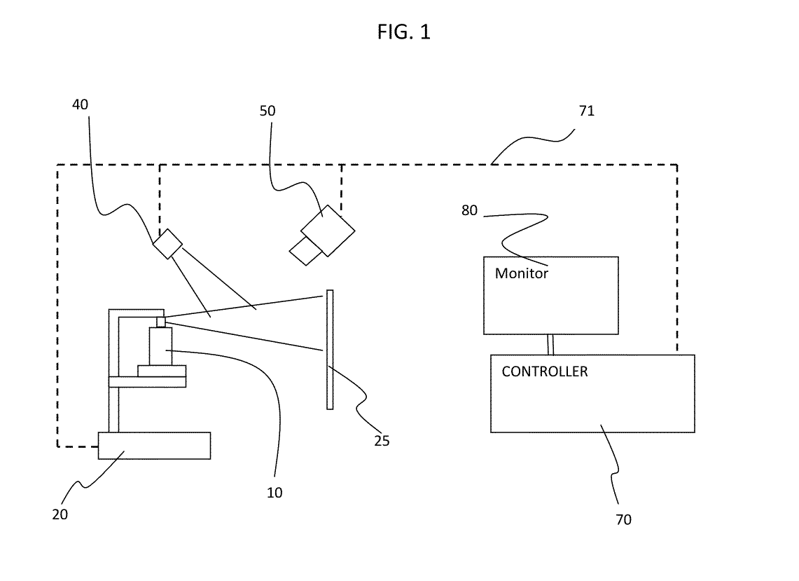

As shown in FIG. 1, the disclosed subject matter is directed to a spray measuring device 1 that can include a controller 70 connected to an actuation mechanism 20, illumination device 40 and camera 50 by a communications system 71. The communications system 71 can be a wired system, or can be any one of various types of wireless communications systems that is capable of communicating image data received at the camera 50 to the controller 70. A monitor 80 can be provided to allow a user to adjust the controller and/or review data and analytical results, etc. A screen 25 can be used to collect additional data (after the spray has passed through a targeted and illuminated area) or to calibrate the system, as a light dump, or to simply collect the spray after the event.

The camera 50 can be a single exposure 640×480 resolution camera, for example. The camera itself can be configured such that it can only take a single exposure over a preset time period (e.g., during a spray event). Thus, the camera can include a shutter (either electrical or mechanical) that is configured to be opened or exposed for a relatively long period of time as compared to video monitor devices. For example, the shutter or exposure can be configured to create an image based on an exposure time greater than 0.1 or 0.2 seconds. The exposure time period could actually be 1 second or longer, if desired, depending on application and lighting, etc.

The controller 70 can be configured to allow for adjustment of the exposure period, for example, by controlling the shutter opening and closing points of time (e.g., total exposure time that a CCD array is actively collecting/sensing data, etc). In addition, it should be understood that the controller can be integrated into the camera device itself or be a combination of the camera device and separate controller, or simply be a separate controller that is connected to the camera 50 to direct and manipulate the camera remotely. The controller 70 can be configured to obtain only a single exposure, e.g., open the shutter of the camera only once for each spray event, and as a result produce only a single image for each spray event. This is in comparison to the 187 to 350 images that are typically produced for each spray event in video cameras. Furthermore the shutter in the camera 50 typically remains open for 0.2 to 0.5 seconds, which is approximately one hundred times longer than the typical exposure time for each image in a high speed video camera

Because the exposure preferably occurs for the entire spray event, the light intensity value which is collected by each pixel will be used directly for analysis. As a result, the disclosed subject matter has an advantage of avoiding the need for both the summing and the scaling calculations that are typically used in conventional devices. Since these summing and scaling calculations are avoided, the potential loss of fidelity associated with these operations can be eliminated in the presently disclosed subject matter.

Another advantage of exposure preferably covering the entire spray event in the spray measuring device is that the entire spray event is captured. Thus fast transient events can be captured in the disclosed subject matter devices whereas the conventional art devices are susceptible to the loss of such events.

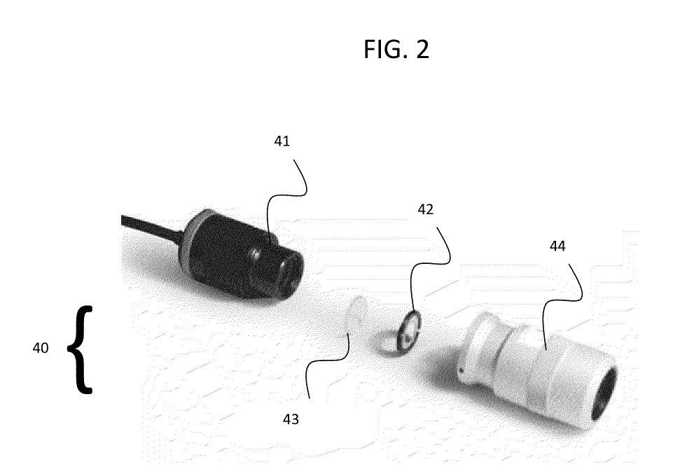

The light source 40 can include a light emitting diode (LED) Pattern Projector, as shown in FIG. 2. In one exemplary embodiment, the light source 40 includes an LED light source 41 configured to emit disperse red light (630 nm) thru patternmask. The light source 40 can also include a lens 44 and pattern 43 that can be selectively located adjacent the LED light source 41 by use of a retaining ring 42. Various patterns 43 can be used and interchanged during use of the light source 40, such that a square pattern, a line pattern, a grid pattern, or other light pattern can be emitted by the light source 40. The power rating of the LED light source 41 can be 3 watts. The LED can be oriented relative to both the camera and the spray device using a C-mount 25 mm lens 44 that projects light at 23 degree angle.

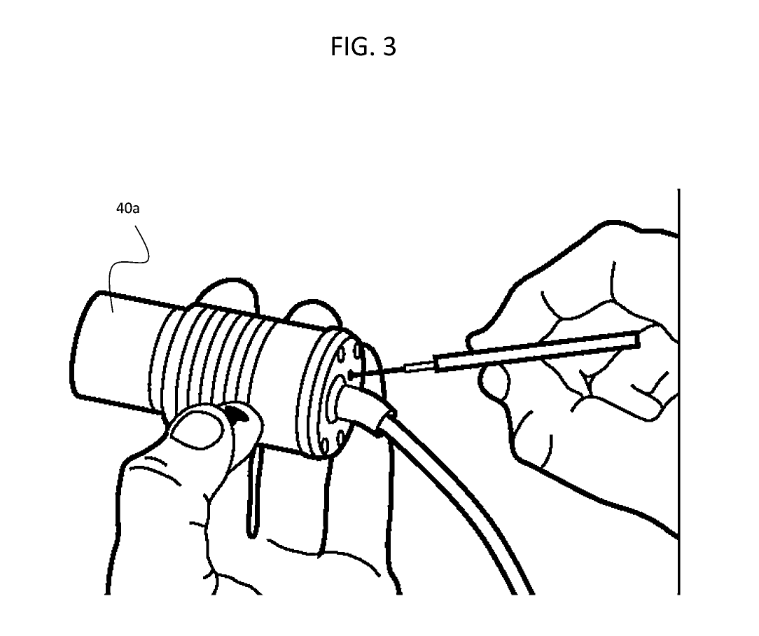

FIG. 3 shows another embodiment of a light source 40a in which an LED light source can be incorporated and manipulated into place in the system.

Because the camera 50 can send unscaled data to the controller 70, no data acquisition board is necessary, and the image data can be sent via Ethernet. In the exemplary embodiment shown, the single exposure spray measuring device 1 performs spray pattern tests only. There are no frames to select, and no cropping required. Only one image is analyzed after the spray event.

The camera 50 can be selected to have good long exposure characteristics (e.g., 1 second exposure). A filter for specific wave length light can be used to filter out noise entering the camera lens. The camera can also include auto-focus features if desired.

The actuator 20 can be a Mighty Runt™ device manufactured and sold by InnovaSystems Inc. The actuator mount can include the features of automatic tip-to-beam adjustment, ability to record nozzle above top plate distance in product file, a hold calibration fixture, an auto placement of fixture in laser beam feature, a hold calibration verification fixture, and an auto placement of fixture in laser beam feature.

The spray measuring device can be fitted with a bottle loader that can load up to 5 bottles into the actuator at a time. The bottle loader can consist of (or include) a tray for holding the bottles and a linear actuator to that moves the bottles into the actuator one at a time. As an option, the bottle loader can also place the bottle on a balance to acquire the weight of the spray that was just captured by the camera. Also, the user can define a spray measurement or analysis method for each bottle in the loader. The method can define the type of capture (pattern or plume), what specific sprays to capture, what tip-to-beam distance to use for each captured spray, and when to acquire the spray weight.

Notably, the spray measuring device 1 does not require the use of a laser. Instead, a light emitting diode (“LED”) can be used as the illumination device 40 that projects a beam of light that impinges on a glass disc that is opaque except for a thin transparent line. As the LED beam impinges on the disc, only that portion of the LED beam that impinges on the transparent line emerges from the disc in the form of a thin sheet. This arrangement is illustrated in FIG. 2 and is available from Opto Engineering, in their LTPR series devices. LED light can be projected from the LED illumination source 40 in the form of an unstructured, substantially circular beam. This unstructured beam impinges on the glass disc, labeled “Pattern,” and only a thin sheet of light corresponding to the thin transparent line will be projected from the glass disc. The thin sheet of light then passes through the “Lens” where it is finally shaped and/or focused according to the particular spray event being analyzed.

LED devices of the type described above do not include a laser, do not produce laser light, and will not produce laser speckle. As a result, the use of this type of LED device for illuminating the spray event removes the potential sources of randomness from the measurement that is possible in the conventional spray measuring devices as a result of the use of the laser to illuminate the spray.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A spray measuring device, comprising:
an actuation device configured to actuate a spray device to create a spray event;
an illumination device;
a camera configured to obtain an image of the spray event based on an exposure time of not less than about 0.1 second; and
a controller in communication with the actuation device, the camera, and the illumination device, the controller configured to obtain an image of the spray event having an exposure time of not less than about 0.1 second.

2. The spray measuring device of claim 1, wherein the camera includes a shutter and the controller is configured to cause the shutter of the camera to open for a period of time greater than 0.2 seconds.

3. The spray measuring device of claim 1, wherein the camera includes a lens having a focal length of from 16 mm to 25 mm.

4. The spray measuring device of claim 1, wherein the illumination device is an LED lamp.

5. The spray measuring device of claim 4, wherein the LED lamp is a 3 Watt LED lamp.

6. The spray measuring device of claim 1, wherein the controller is configured to keep the camera exposure open for a time period of from 0.1 to 1 seconds.

7. The spray measuring device of claim 1, wherein the controller is configured to keep the camera exposure open for a time period of from 0.2 to 0.5 seconds.

8. The spray measuring device of claim 1, wherein the controller is configured to keep the camera exposure open for a time period longer than 0.1 seconds.

9. The spray measuring device of claim 1, wherein the controller includes a portion integrated into the camera.

10. The spray measuring device of claim 1, further comprising:
a monitor, and the controller is connected to the monitor.

11. A method for measuring a spray event, comprising:
providing a camera, and a spray device configured to be actuated to create a spray event;
actuating the spray device to cause the spray event;
operating the camera to obtain a single, and not more than one, exposure of the spray event.

12. The method of claim 11, further comprising:
providing an actuation device configured to cause the actuation of the spray device;
providing a controller in communication with the actuation device and the camera and configured to cause the camera to obtain an exposure of one single time period during the spray event.

13. The method of claim 11, wherein said camera has a shutter and wherein opening and closing the shutter on the camera includes opening the shutter of the camera for a period of time greater than 0.1 seconds during the spray event.

14. The method of claim 11, wherein operating the camera includes causing a single exposure having a time period greater than 0.2 seconds during the spray event.

15. The method of claim 11, wherein operating the camera includes causing a single exposure having a time period having a range from 0.1 to 1 seconds.

16. The method of claim 15, wherein the time period is a range from 0.2 to 0.5 seconds.

17. The method of claim 11, further comprising:
analyzing a light intensity value which is collected directly and without scale factoring from each pixel of the camera.

18. The method of claim 11, further comprising:
providing a controller and a monitor, the controller configured to cause the camera during the spray event to obtain a single exposure of the spray event.

19. The method of claim 11, further comprising:
obtaining data related to the spray event from the camera and storing the data in a controller, wherein the data is representative of at least one of a spray plume, spray pattern, particle size, and particle distribution.

20. The method of claim 11, further comprising:
illuminating the spray event with an LED light source.
